(19) United States
(12) Patent Application Publication
(10) Pub. No.: US 2012/0116987 A1
(43) Pub. Date: May 10, 2012

(54) Dynamic Process Modeling Assembly and Method of Use

(75) Inventors: Darby E. Hering, Charlestown, MA (US); Charles Kapopoulos, Nashua, NH (US); Mark Weston, Arlington, MA (US); Jared Freeman, Bethesda, MD (US)

(73) Assignee: APTIMA, INC., Woburn, MA (US)

(21) Appl. No.: 13/319,764

(22) PCT Filed: Jul. 16, 2010
(86) PCT No.: PCT/US10/42207

§ 371 Date: Nov. 10, 2011

Related U.S. Application Data
(60) Provisional application No. 61/288,878, filed on Dec. 22, 2009.
(60) Provisional application No. 61/230,639, filed on Jul. 31, 2009.

(51) Int. Cl. G06Q 10/00

(52) U.S. Cl. 705/348

(57) ABSTRACT

A method for modeling a process comprising receiving a first formatted data input representing a process element and a second formatted data input representing a process element, executing a simulation and determining a measure representing the simulation of the process element given the entity element. In some embodiments, the process element represents a business process and the entity element represents a resource unit and the simulation comprises a temporal simulation. Some embodiments further comprise the measure being a completeness measure associated with a decay rate or a repair rate. Some embodiments also include the measure comprising an information product completeness measure. Some embodiments also include automatically determining the process element and the entity element. Systems, to include processor based embodiments having a computer program product to perform the methods are also disclosed.

### CROSS-REFERENCE TO RELATED APPLICATIONS

This application claims the benefit of U.S. Provisional Patent App. No. 61/230,639, filed on Jul. 31, 2009, entitled “Use of Dynamic Models and Operational Architecture to Solve Complex Navy Staffing Challenges,” the entire contents of which are incorporated herein by reference. This application also claims the benefit of U.S. Provisional Patent App. No. 61/288,878, filed on Dec. 22, 2009, entitled “DYNAMIC PROCESS MODELING ASSEMBLY AND METHOD OF USE,” the entire contents of which are incorporated herein by reference.

### STATEMENT REGARDING FEDERALLY SPONSORED RESEARCH OR DEVELOPMENT

This invention was made with Government support under Contract # N65236-08-C-3106 awarded by the U.S. Navy. The Government has certain rights in the invention.

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates to systems and methods of modeling processes, in particular automatic modeling of processes given resource units to satisfy the process.

2. Description of the Prior Art

The United States Navy established a number of Maritime Operations Centers (MOC) to enhance its command and control of forces at the operational level of warfare. The Navy developed the MOC concept to enhance its command and control of forces at the operational level of warfare. To oversee the development of the MOC concept, the Navy gave United States Fleet Forces Command (USFFC) the responsibility to standardize MOC staff functions and processes. This standardization enables interoperability with the joint community and promotes commonality across all Fleet and principal headquarters. USFFC used the Department of Defense Architecture Framework (DoDAF) to develop Business Process Models (BPM) for MOC processes. These BPMs, called Operational Views (OV-6c) in DoDAF, define MOC processes, their sequence, the organizational elements that execute them, and the products of those work activities.

### BRIEF SUMMARY OF THE INVENTION

The following summary is included only to introduce some concepts discussed in the Detailed Description below. This summary is not comprehensive and is not intended to delineate the scope of protectable subject matter which is set forth by the description and the claims presented.

Embodiments of the dynamic modeling systems and methods disclosed, are able to transform the static DoDAF documents into an executable software model called the MOC Performance Assessment Tool (MOC-PAT). The MOC-PAT supports decisions regarding MOC configuration, such as whether a staffing plan is adequate to execute the many MOC processes required to execute a specific mission at a specified operational tempo. The first application of this tool supports planning and execution of Navy exercises to accredit Fleet MOCs.

It is an object of one embodiment of the invention to provide a computer based process for linking activities in an activity model comprising the steps of receiving a set of first process elements representing a first activity, receiving a set of second process elements representing a second activity, each set of process elements having at least one linking element, and linking the first and second set of process elements according to the linking element.

It is another object of one embodiment of the invention to provide a computer based process wherein the linking element comprising an information product, each activity has an activity completeness measure, the information product has an information product completeness measure, or the information product further comprises a completeness decay rate influencing the information completeness measure.

It is yet another object of one embodiment of the invention to provide a computer based process for automatically determining measures comprising the steps of defining a process element representing at least one activity, defining an entity element representing an entity, and automatically determining a measure of the entity or entity element to satisfy the at least one activity by comparing the process element to the entity element.

It is an object of one embodiment of the invention to provide a dynamic process modeling assembly comprising a specially programmed computer having a computer program product to determine an information product completeness measure.

It is an object of one embodiment of the invention to provide a computer based method for modeling a process comprising receiving a first formatted data input comprising a process element, receiving a second formatted data input comprising an entity element, executing a process simulation with the first and second formatted data inputs and determining a measure whereby the measure represents the process simulation of the process element given the entity element. In some embodiments, the process element is at least one attribute of at least one business process or the entity element is at least one attribute of a least one resource unit.

It is another object of one embodiment of the invention to provide the computer based method wherein the process element defines at least one appropriate entity element to be used in the execution of the process simulation and the step of executing a process simulation further comprises the step of determining whether the process element has the appropriate entity element and the step of performing a process simulation of the process element given the entity element.

It is yet another object of one embodiment of the invention to provide the computer based method wherein the measure is a completeness measure. In some embodiments of the computer based methods, the completeness measure is associated with a decay rate whereby the process simulation modifies the completeness measure according to the decay rate and in some embodiments the completeness measure is associated with a repair rate whereby the process simulation modifies the completeness measure according to the repair rate.

It is another object of one embodiment of the invention to provide the computer based method wherein the completeness measure is a linking element required by a second process element or the process simulation creates an information product and the measure is an information product completeness measure.

It is yet another object of one embodiment of the invention to provide the computer based method wherein the information product completeness measure is associated with a decay rate whereby the process simulation can modify the information product completeness measure according to the decay rate. In some embodiments, the completeness measure is associated with a repair rate whereby the process simulation modifies the completeness measure according to the repair rate.

In some embodiments, the information product is a linking element required by a second process element.

It is a further object of one embodiment of the invention to provide the computer based method wherein the process element is at least one attribute of at least one business process, the entity element is a resource unit, the process element defines an appropriate entity element to be used in the process simulation of the process element, the step of executing the process simulation further comprises determining whether the entity element has the appropriate entity element and performing a temporal process simulation of the process element given the entity element, the temporal simulation creates an information product and the measure is an information product completeness measure and the information product completeness measure is associated with a decay rate whereby the temporal simulation can modify the information product completeness measure according to the decay rate.

It is an object of one embodiment of the invention to provide a computer based process for automatically modeling a process comprising the steps of receiving a first formatted data input representing a process element, receiving a second formatted data input representing an entity element, executing a process simulation with the first and second formatted data inputs and determining a measure whereby the measure represents execution of the process simulation of the process element given the entity element. In some embodiments, the first formatted data input comprises at least one table having the process element and the process element represents a Joint Mission Essential Tasks List. In some embodiments the process element is at least one attribute of at least one business process and the at least one attribute of the business process can be formatted according to a Design Primitives and Patterns, Guidelines for the Design of Business Process Models. In some embodiments, the second formatted data input comprises at least one table having the entity element and the entity element can represents a billet.

It is yet another object of one embodiment of the invention to provide the computer based process wherein the first formatted data input comprises at least one table having the process element, the second formatted data input comprises the at least one table having the entity element, executing a process simulation of the process element given the entity element and determining a measure whereby the measure represents execution of the process simulation of the process element given the entity element. In some embodiments, the measure comprises a completeness measure and the completeness measure can be associated with a decay rate whereby the process simulation can modify the completeness measure according to the decay rate.

It is an object of one embodiment of the invention to provide a computer based process modeling system comprising receiving functionality to receive a first formatted data input representing a process element and a second formatted data input representing an entity element, executing functionality to execute a process simulation with the first and second formatted data inputs and determining functionality to determine a measure representing the process simulation of the process element given the entity element. In some embodiments, the process modeling system further comprises a computer having a computer program product, the receiving functionality is provided by the computer program product having an input adapter module, the executing functionality is provided by the computer program product having a temporal model within an engine model and the determining functionality is provided by the computer program product having an algorithm model within the engine model. In some embodiments, the computer based process modeling system further comprises a computer having a computer program product to automatically define the process element, the entity element and determine the measure.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a process diagram of one embodiment of the methods of the invention;

FIG. 2 illustrates a more complex process diagram that includes the entities involved and linkages between process elements;

FIG. 3 illustrates one embodiment of entity information;

FIG. 4A illustrates one example embodiment of a raw process element as a Component Table populated with process and entity variables;

FIG. 4B illustrates one example embodiment of the linking of raw process and entity elements;

FIGS. 4C and 4D illustrate one example of details of raw process and entity variables in a Parameter Table;

FIGS. 5A-5E illustrate example embodiments of the raw entity and process elements that are translated for use by the application specific engine model;

FIG. 6 illustrates one example embodiment of the methods of dynamic process modeling;

FIG. 7 illustrates a function diagram of the computer program product of the dynamic process modeling assembly; and

FIG. 8 illustrates a function diagram of one embodiment of a specially programmed computer implementation of the dynamic process modeling assembly.

### DETAILED DESCRIPTION OF THE INVENTION

A dynamic process modeling assembly and method of use will now be described in detail with reference to the accompanying drawings. It will be appreciated that, while the following description utilized examples of an assembly that models military organization readiness and capabilities, the systems and methods disclosed herein have wide applicability. For example, the assembly and methods described herein may be readily employed with manufacturing resource planning, training, project management or commercial business organizations. Additionally, potential application of the methods can address issues across the standard dimensions of military operations, namely: doctrine, organization, training, materiel, leadership, personnel, and facilities. Notwithstanding the specific example embodiments set forth below, all such variations and modifications that would be envisioned by one of ordinary skill in the art are intended to fall within the scope of this disclosure.

Specific to the U.S. Navy, the Chief of Naval Operations mandated that each MOC be accredited to validate its proficiency at MOC core tasks. The disclosed dynamic process modeling assembly (MOC-PAT) is used to support this process by analyzing the performance of selected MOCs during accreditation. The MOC-PAT is able to populate BPM variables with manning information based on existing MOC manning documents and role data (developed from surveys and onsite observation) and process activity workload observations (i.e., time to complete activities, or work products required to complete activities). These data are then available to support model runs to analyze MOC staff execution and support accreditation events.

The model leverages pre-existing operational process architecture, joint military task lists that define activities and their precedence relations, as well as Navy documents that specify manning and roles per activity. The software model serves as a “computational wind-tunnel” in which to test a MOC on a mission, and to refine its structure, staffing, processes, and schedules. More generally, the model supports resource allocation decisions concerning Doctrine, Organization, Training, Material, Leadership, Personnel and Facilities (DOTMLPF) at MOCs around the world.

With this simulation, the MOC-expert user is able to configure the particular mission s/he would like the simulation to “play,” and the MOC organization is then evaluated against this mission scenario. More specifically, the model enables analysts to answer several questions about MOC activities:
The Activities: Do activities get the resources they need? Which processes & activities began with incomplete resources: human, information, time? Which activities could not begin at all?
The Organization: Do we have enough staff in the right roles? Which organizational elements & staff were overloaded? Which were under-loaded?
The Information Products: Are the information products complete and current when they are needed? What information was incomplete or missing when it was needed?

MOC-PAT answers these questions in a process that consists of several general stages: (1) define process variables and elements, (2) define entity variables and elements, (3) define the linking elements, (4) receive the variables and elements in the system, (5) configure the data if needed, (6) run a simulation to determine the measures needed, and (7) analyze the results. The analyst then typically returns to stage (5), to refine the configuration and continue analysis iteratively.

The following terms are defined below as they are used throughout this description:

A process is a single or series of actions, changes or functions that by themselves or with others bring about a result. For example and not for limitation a process can comprise the actual, cognitive or virtual activities performed by parts of an organization to satisfy their organizational goals or the tasks required to complete portions of a construction project.

A process element is a representation of one or more subtasks, activities, products, components, thresholds or inputs that are part of a process and can be used to help define a process variable. The representation may be numeric or mathematical or any representation that can be included in a computer program product such as computer software.

A process variable is a representation of at least one process element and by itself may define a process, mission, activity, or a series of processes or activities. The representation may be numeric or mathematical or any representation that can be included in a computer program product such as computer software. A process variable can function similar to a node in a business process diagram.

An entity is a thing that exists as a particular unit. An entity, as used in this description can be an actual thing, a virtual thing or a representation of either. For example and not for limitation an entity can comprise a business or governmental unit, a person, an investment vehicle, a set or resources or other type of unit.

An entity element is a representation of one or more characteristics or components of an entity. For example and not for limitation an entity element can comprise a head count, a skill set, a skill level, a specific person, an investment vehicle or a measure or equation representing any of these.

An entity variable is a representation or parameter of any type of resource, entity or entity element that may be used to satisfy a process variable or process element. The representation may be numeric or mathematical or any representation that can be included in a computer program product such as computer software. An entity variable can be a single entity element or it can be a combination of a set of entity elements. For example and not for limitation an entity variable can comprise a military unit, a business department, a team of individuals, a pool of investment vehicles or a single person.

A linking element is an entity element, an entity variable, a process element or a process variable that links one process element or process variable to another in a process flow.

A measure is a representation of a variable or element or any multiples or combinations to satisfy another variable or element or any groupings thereof. For example and not for limitation, a measure may represent the ability of an entity, an entity variable or an entity element to satisfy a process, a process node, a process variable or a process element.

### Dynamic Process Modeling Method Overview:

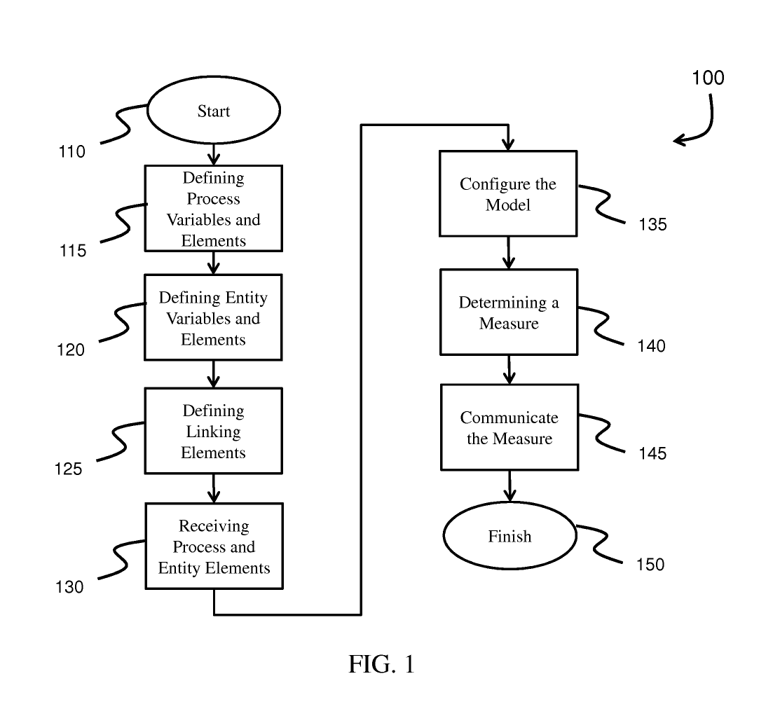

FIG. 1 illustrates an overview of one embodiment of a dynamic processing method. As shown, after the process starts at 110, step 115 comprises defining process variables and their corresponding elements. The process variables are representation of a process or activity such as, but not limited to, a business process step or an organizational task. The process variables can be represented in any manner.

The process elements represent a characteristic of the process variable so that the variable can be represented in a model such as a mathematical algorithm implemented in a computer program product. Typically, the elements are numeric, mathematical representations or relationships that can be inputted into a computer program product. The elements can positively define process variable characteristics and their absence can define process elements missing, or requirement shortfalls such as entity requirements to satisfy the process variable.

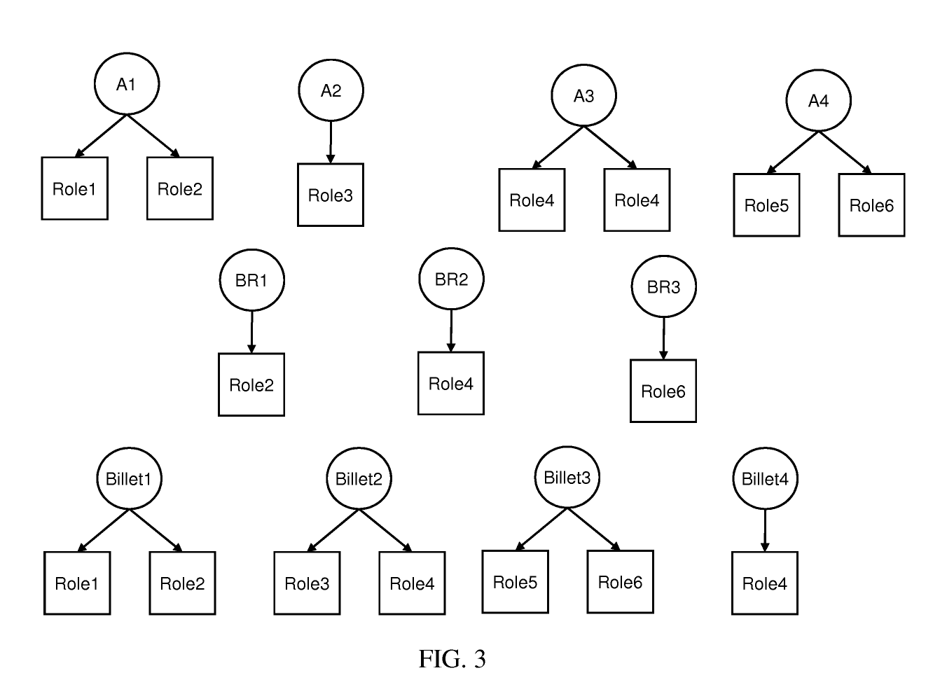

Referring back to FIG. 1, at step 120, the entity variables and elements are defined. The entity elements are representations of an entity and include the entity variables that that can be used as input to a model such as a mathematical algorithm implemented in a computer program product. One example of a source of entity information is shown in FIG. 3. Entity variable and elements are defined to represent resources used to satisfy the process variables and elements. Similar to the process variables, the entity variables are typically numeric, mathematical representations or relationships that can be inputted into a computer program product.

At step 125, linking variables and linking elements are defined. The linking variables are those process or entity variables that are related to other process or entity variables. The linking of the variables or elements is a characteristic of those variables and elements.

It is understood that the previous steps do not need to be done in any order. It is also understood that some embodiments of the methods can be performed with the elements and variables already being defined and the process begins by receiving the elements or variables.

At step 130, the process and entity elements are received so that they can be submitted as input to a temporal and algorithm model in an engine model.

At step 135, the model is configured. This optional step can allow for altering of the process and entity variables or elements. For example, entity element levels may be altered to allow a comparison of one model execution with one set of elements versus another model execution with another set of elements. In addition, thresholds can be defined and modified during this configuration step for variables or elements. This threshold can be used as a type of measure to gauge or gate the process based on how the threshold.

At step 140, a measure is determined by the execution of a process simulation of the process element or variable that is performed by execution of the temporal model and an algorithm model within the engine model. The temporal model starts executing a temporal process simulation of the process element by receiving and populating a queue of process variables with selected process elements and appropriate entity elements. For example, the temporal model will receive and be populated with a partial list of a queue of process variable or elements that will be executed. Some of the process variables or elements are linked to entity variables or elements with which they will be combined when the algorithm model is executed. The result or receiving this process and entity data is a populated temporal model reflecting both process and entity elements (which represents the process and entity variables). Once the population is complete, the temporal model begins execution of its process and entity variables. The temporal model is then further executed with these elements and in conjunction with measure calculations requested from and returned by from the algorithm model so that it reflects the process and entity elements in a temporal process simulation across that temporal space.

At step 140, the engine model also executes a process to determine a measure, m=f(V_{P}, V_{E}), where V_{P} are process variables and V_{E} are entity variables. The measure is determined by receiving formatted process and entity variables and executing an algorithm model with these alongside the temporal model. When the temporal model considers assignments of entity variables to process variables, according to the internal temporal period reached in the temporal model and the process element(s) associated with the next process variable(s) in the process queue, a measure can be calculated by the algorithm model. The measure can represent a measure of the entity element(s) or entity variable(s) ability to satisfy process element(s) or variable(s). The result of the measure calculation can also determine the way forward within the temporal model and can also be preserved for output to the user at the end of the model execution.

It is understood that the engine model can iterate through multiple processes and entities. The engine model can also execute other processes such as determining a decay rate as defined below.

At step 145, the measure is communicated to an output adapter. The output adapter translates the measure from its internal format to a format suitable for visualization or other action. The engine model creates a simulation run component that associates all measure output together including the translated visualization data and persists it for future analysis or other action by communicating it back to the database. From the database, the visualization data may be requested from a user interface for display or other communication to a user.

In certain embodiments, the communication of the measure is to provide the measure as a linking element and/or an input to another process or entity element.

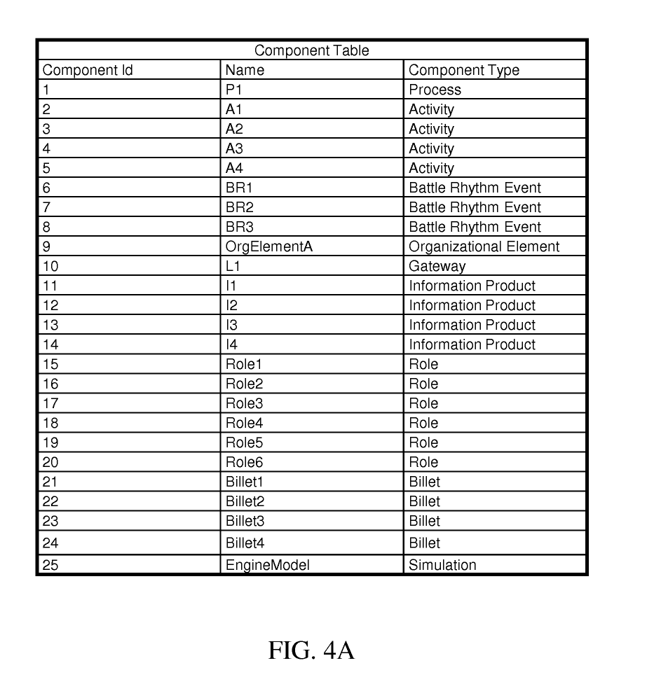

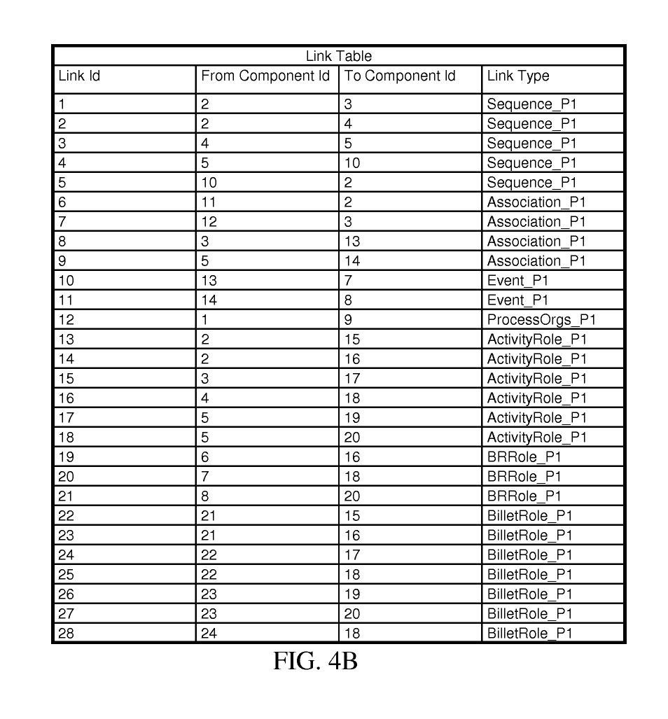

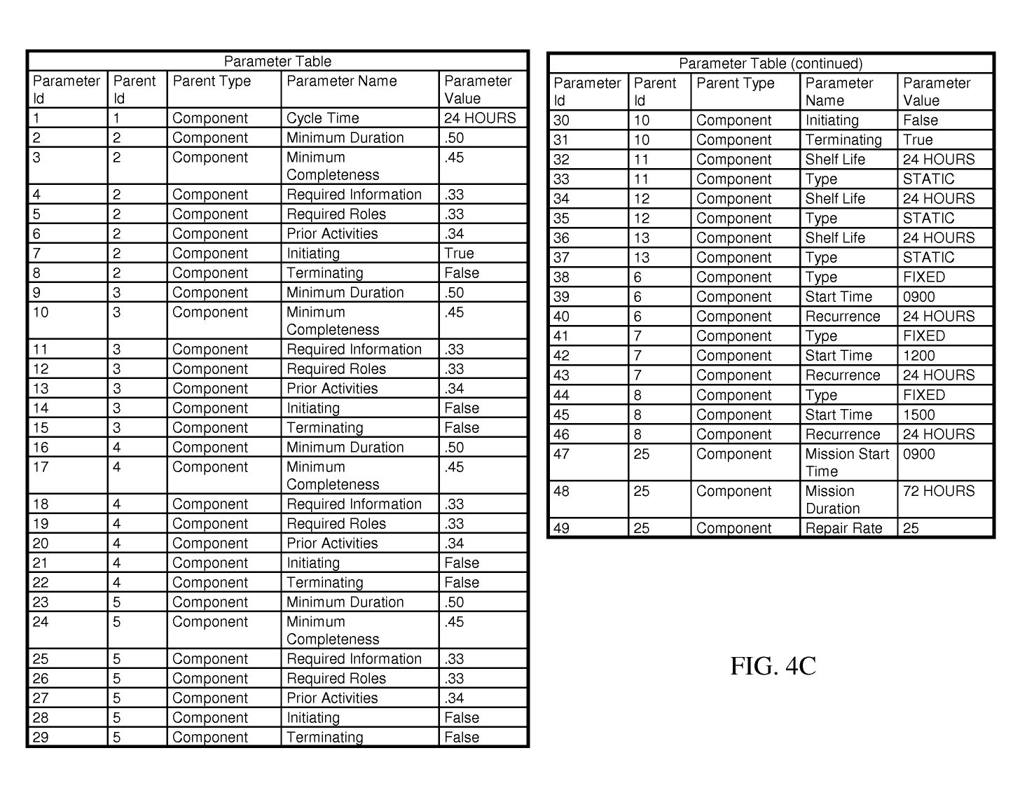

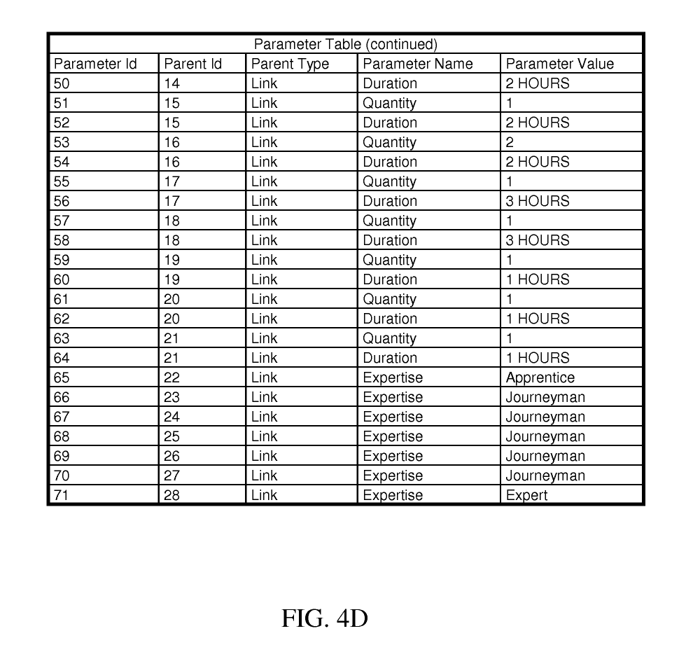

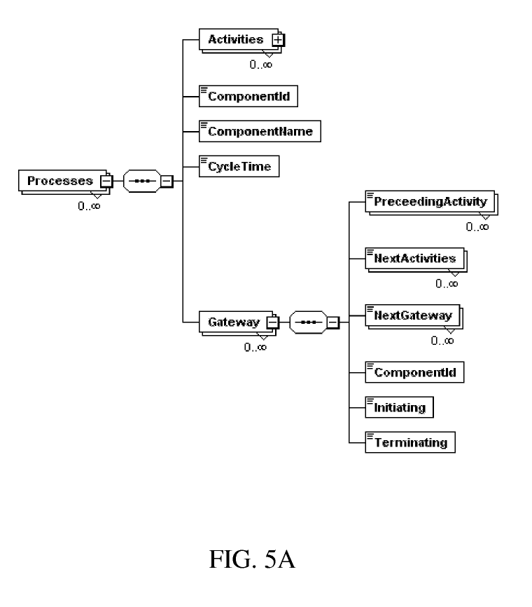

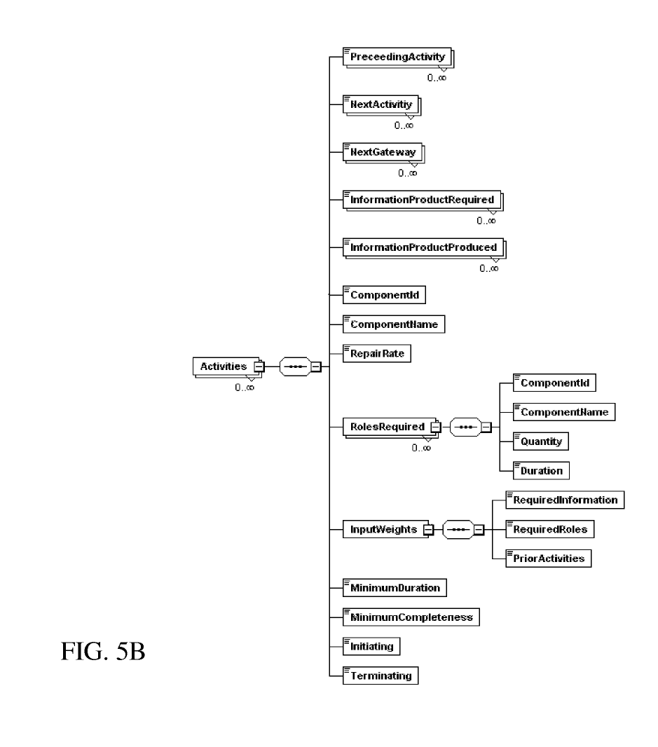

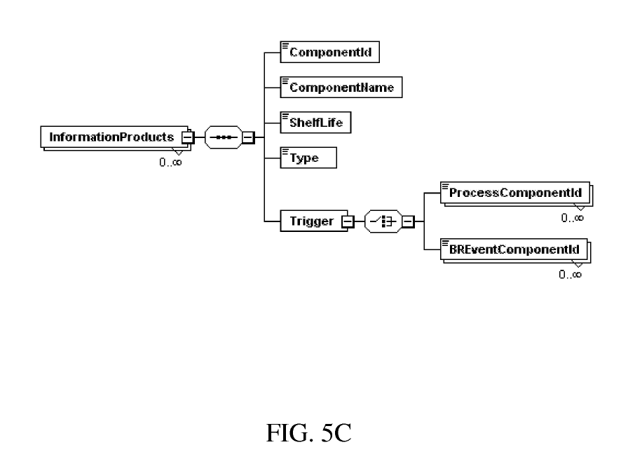

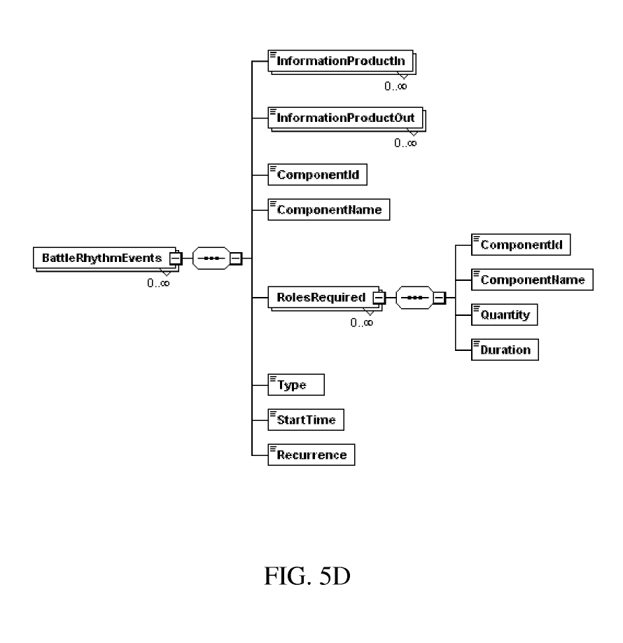

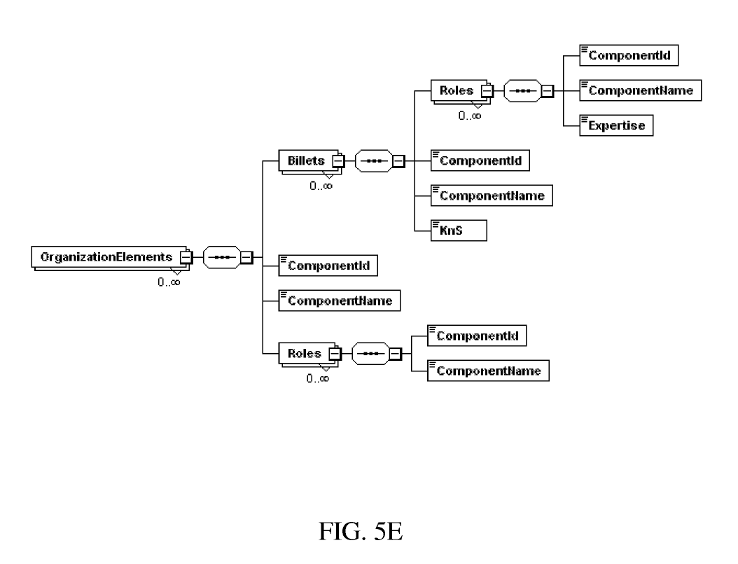

In certain embodiments, the variables can be defined such that they can be provided directly as or elements to the engine model. In other embodiments, which are expected to be more common, it is expected that the elements or variables will be received in one format, a raw format, and will need to be translated to another format. One example of raw formatted process and entity variables and elements is shown in the tables of FIGS. 4A-4D. This raw formatted data is then used as application specific data, directly or after translation, as shown in FIGS. 5A-5E. The translation or population of the elements and variables can be manual or it can be automated. In certain embodiments, the translation of the elements and variables into the application specific format is done by an import adapter that translates one or more external formats to the application specific format. The application output data is then persisted in a central database where it can be modified by an analyst.

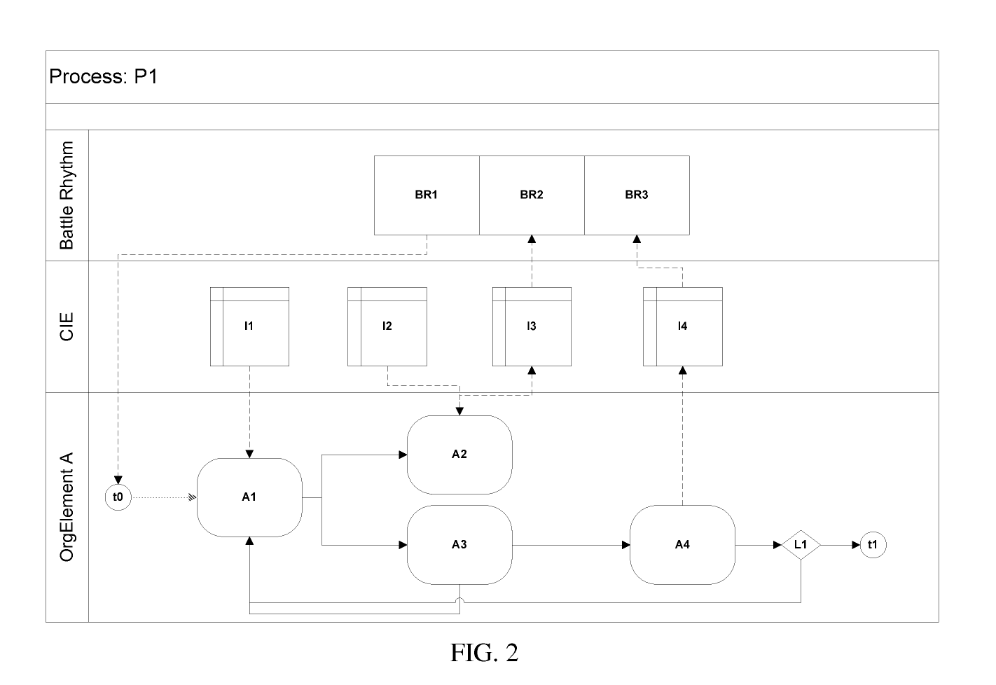

In certain embodiments, it can also be expected that the original format of the process and entity information, being represented by the process and entity variables, will need to be translated into the raw format. For example, but not for limitation, the process may be defined in a process flow chart or in a software project plan. As one example, the formatted data in FIGS. 4A-4E have been formatted from the representations in FIGS. 2 and 3 as described before. The process variables and elements can be created by manually entering a representation of the process flow into forms, tables, databases or mark-up languages such as XML capable of being translated into process variables. Similarly, as an example and not for limitation, entity variables and elements can be created by manually entering a representation of an organization chart into formats capable of being translated into entity variables and elements. In certain embodiments, the translation of the process and entity into raw process and entity variables and elements is done by the import adapter using data formatting tools such as but not limited to XML or UML.

In certain embodiments, a decay rate is used as an element of the algorithm model. The decay rate may be user-configurable. In some embodiments, the measure calculation in the algorithm model incorporates decay rate to show the effects of the passage of time decreasing the relevance or potency of some process or entity elements that have not been updated recently enough by activation of their associated process element. Decay rates and equations can take many forms, including exponential decay, in which, given an entity element state at time t, s(t), a decay constant, λ, and a change in time, Δ, s(t+Δ)=s(t)e^{-λΔ}.

Repair rate is also a potential element that may be used in the algorithm model. The repair rate may be user-configurable. The measure calculation in the algorithm model uses the repair rate to incorporate the ability of systems to heal or repair over time given stable conditions following a period of less than ideal conditions.

### One Embodiment of the Dynamic Process Modeling Method:

Operation of one embodiment of the dynamic processing method comprises the steps of defining a set of process variables, representing activities and a set of entity variables representing attributes of an entity, linking process variables according to a linking element, determining a measure of the ability of the entity variables to satisfy the process variables and communicating the measure.

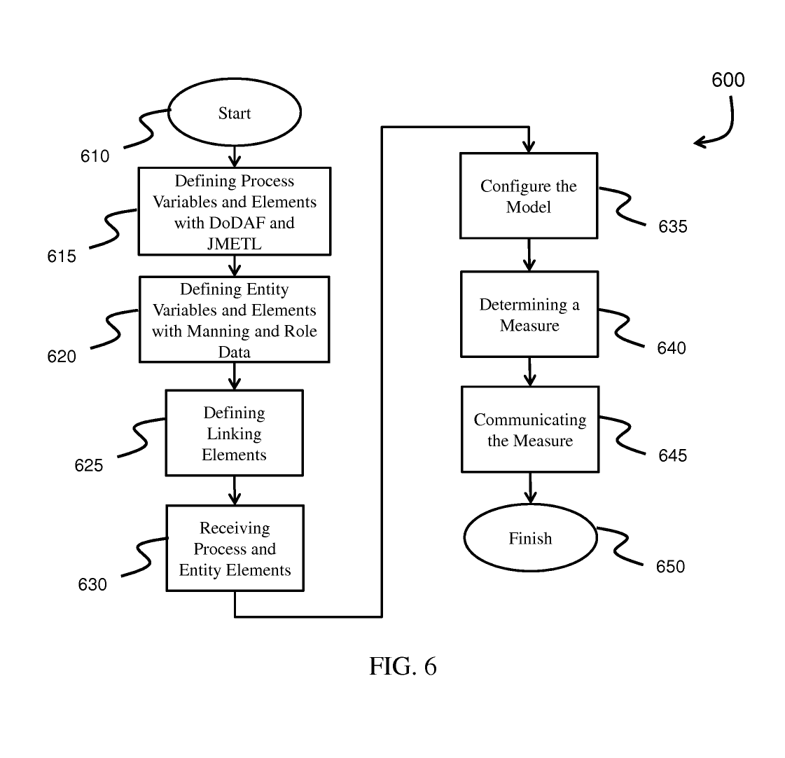

For purposes of illustrating the operation of one embodiment of the dynamic processing method, and not for limitation, for measuring the ability of naval units to satisfy naval process and task lists is summarized in FIG. 6.

As shown in FIG. 6, the process of operation starts with Step 615 which comprises defining process variables and process elements.

In this embodiment, the process variables comprise MOC business process measures (BPMs) representing processes and activities within each process. These BPMs were created by the Navy using the DoDAF standard OV-6c format as described in the Enterprise Architecture based on Design Primitives and Patterns, Guidelines for the Design of Business Process Models (DoDAF OV-6c) using BPMN, dated Apr. 27, 2009 and published by the U.S. Department of Defense Business Transformation Agency and which is herein incorporated by reference in its entirety. The DoDAF is well known in the art of Department of Defense organizational analysis and defines a standard and consistent way to organize a system's architecture into complementary and consistent views. An example of one of the formats from this standard is shown in FIG. 2. FIG. 2 shows a process flow diagram of which activities A1-A4, represent a process variable such as a task of “Direct Aircraft to Battle Area”. In FIG. 2, I1-I4 represent process variables such as information products and BR1-BR3 represent process variables such as Battle Rhythm Events. The different process variables together represent process variable P1, such as a business process having multiple activities. Typically, these diagrams are developed to support acquisition decisions and reside in a central Navy architecture repository, the Syscom Architecture Development and Integration Environment (SADIE). The MOC-PAT leverages these documented MOC process and uses them to develop accurate models of the operating MOC by linking the processes back to Joint Mission Essential Tasks Lists (JMETL). A JMETL task includes the conditions under which the task is to be performed, to the standard to which the task is to be performed, as well as a standard task listing. Preferably, core missions that a MOC staff is required to execute are identified and then these are related to the associated JMETL tasks.

For example, while the processes are executed, a fixed schedule of battle rhythm events (BRE) occurs, as shown BR1-BR3. BRE's include events such as special working group meetings and regular briefs to senior staff. The BRE and the activities produce and consume and sometimes require information products, and these well-defined products serve as the linkages between different parts of the organization and their many processes and BRE. For example, a planning activity, A4, may produce a plan (a document), I4, that is a required input to an assessment activity, BR3, to communicate which indicators of progress should be monitored.

In this example, process elements comprise JMETL tasks, BRE and OV-6c processes and activities together with their user-configured parameters. As a process element defined by a standard, these elements are able to be predictably mapped to process variables using tools such as or similar to XML (Extensible Markup Language), UML (Unified Modeling Language) or any other means of consistently recognizing and mapping elements to other elements or variables.

These process elements are able to populate process variables such as tasks, subtasks, scheduled events, role requirements for each task and scheduled event, the cycle times on which to restart recurring tasks, and scheduled occurrence times for the scheduled events. These elements populate tables such as those illustrated in FIGS. 4A-4D and are used to populate the internal parameters and variables defined in the equations below. FIG. 4A-4D illustrates one example of the process variable populated with related process elements. Throughout these tables, process variables are generally represented as a component with a component ID as shown in FIG. 4A and links with a link ID to other components as shown in FIG. 4B. In these tables, process elements are generally represented as parameters related back to the variables either through the component ID or the link ID as shown in the Parameter Tables of FIGS. 4C and 4D.

Examples of other process elements include but are not limited to: information products that result from process elements, such as a written report, a form or a database entry; duration of a process element or a series of process variables; required completeness thresholds for tasks or activities; a task; a resource; a skill; and an activity.

Referring back to FIG. 6, step 620 comprises defining entity elements reflecting attributes of entity variables. Manning information based on existing MOC manning documents and role data (developed from surveys and onsite observation) is combined with process activity workload observations (i.e., time to complete activities, or work products required to complete activities) to populate the entity variables in MOC-PAT.

The MOC organization that will accomplish this mission is made up of multiple organizational units (OU). Each OU has several billets (individuals) assigned to it, and each billet is assigned a collection of roles s/he may take on, one at a time throughout the mission. These roles currently serve as proxies for more detailed information about billets' associated knowledge and skills. As shown in the embodiment of FIG. 3, entity variables may comprise a variable such as, but not limited to a billet or role type or both.

In this example, entity elements comprise individuals, organizations, roles, the abilities of the individuals to fulfill the roles, other indications of individuals' capabilities, and the durations required for each role to complete each subtask. As shown in FIG. 4A, these entity variables are mapped as components with component and link IDs similar to the process variables. Also, the entity variables are related to entity elements, shown as parameters, through the component or link IDs as shown in the Parameter Tables of FIGS. 4C and 4D.

Examples of other entity elements include but are not limited to: resource units such as a headcount, a billet or a military organizational unit; an investment vehicle; a processing unit; an information system or other technology; training qualifications or certifications; and funding.

Referring back to FIG. 6, step 625 comprises defining linking elements such as an information product, a resource or a duration.

In the example discussed, linking elements comprise information products, such as documents, and subtask precedence relationships. In this embodiment, examples of linking variables are shown in the Link Table in FIG. 4B where one component ID is linked to another component ID and assigned a link ID. Linking elements are those elements that are related to other elements and examples of these are shown in the Parameter Tables of FIG. 4D where the parent type is of a link type. In the embodiment shown in FIG. 6, an example of a linking element comprises a report that results from the process variable or element being modeled.

Referring back to FIG. 6, step 630 comprises receiving sets of process and entity elements to populate the process and entity variables. With the process and entity variables and elements defined, the elements need to be translated into the associated variable or element so that they can be executed in a computer program product executing a process simulation of the process element with the engine model.

FIGS. 5A-5E illustrate one embodiment of how different process and entity elements can be used as input to the engine model. For example, to model processes (such as P1 of FIG. 2), FIG. 5A shows that you need the elements of ComponentID, ComponentName and CycleTime as well as the variables of the Activities and the Gateway with their elements. Similarly, the other example elements and variables shown in FIGS. 5B-5E can be used as input for the engine model.

In one embodiment, the data used in the engine model includes: billet information, which can be imported from existing command manning documents or manually input through the MOC-PAT configuration interface; role information, which specify the jobs or roles needed to accomplish activities (note that multiple roles can be assigned to individual billets); process diagrams imported from the approved OV-6c diagrams; the “Battle Rhythm”, or daily schedule of leadership meetings and roles of attendees; and the information products that each activity in the process model requires and creates.

The data used in the MOC-PAT originate from authoritative sources. The entity elements include: billet information from Activity Manning Documents; role information from on-site observation, as well as survey results and workshop interviews; and organization information from the architecture of the MOC. The process elements include: process diagrams that relate processes, activities, information products and Battle Rhythm Events from the SADIE architecture repository; the Battle Rhythm from a MOC's schedule; and mission-specific tasks from the Universal Joint Task List (UJTL) and an analysis of the assigned mission. The analyst selects these mission tasks with a user interface module communicating with the configuration component, and the MOC-PAT then automatically identifies the processes to run based on a mapping by USFFC N5-OLW of tasks to processes.

Step 635 comprises the optional step of configuring the model that determines the measures in Step 640. This step is optional in that in some embodiments, the computer program product allows a user to modify some of the process variables or elements or the entity variables or elements to determine the results of “what-if” scenarios. With this step, the analyst can generate additional configurations easily in the model and specify the length of a given mission to test the durability and reliability of an organizational configuration. In some embodiments, this configuration is also able to select or modify the measures that can be obtained from Step 640.

In this embodiment, the work performed utilizing these methods was based on a number of assumptions to include:
Billets are available to work 24 hours each day
The MOC is operating under Normal and Routine conditions
Each process begins at scheduled times, according to user-specified cycles
Each activity cannot begin until its preceding activities (within the process) are concluded
If an activity is prompted to start at time t (by the schedule or by the conclusion of its preceding activities), then it must conclude at a deadline created by adding the longest required processing time by any of its roles to this earliest triggered start time

Step 640 comprises determining a measure of comparing the entity variables to the process variables. Typically, although not necessarily, this comprises a measure of the entity or entity element's ability to satisfy the process variable or process element.

In the example embodiments discussed above, the measure for determining the effectiveness of each activity in the mission comprises information product completeness, required role availability, and completeness of previous, related activities. The user is able to specify, for each activity individually, the weights or thresholds that should be used in combining these three measure components, as shown in the “activity potential completion” equations below. The first measure component, information product completeness, can be influenced by several factors including one factor that that each information product is given a “shelf life”. This is the amount of time the information in each kind of product is judged to be valuable and current for the mission. Each time an information product is updated by an activity or battle rhythm event, its completeness returns to 100% and remains there for the duration of the shelf life. After this time, the completeness of the information product decays as the information becomes increasingly outdated. Another factor influencing information product completeness can include completeness due to having insufficient time periods, skills or inputs that prevent the information product to be 100% complete. These factors can be configured by the user. When an activity is about to start, it records the current level of completeness, or currency, for each information product that it requires. The second measure component, required role availability, is the percentage of the roles required that are available when the activity begins. For the third component, completeness of the previous activities, we average the completeness levels of the preceding activities linked to the one about to begin.

In the embodiment of the methods described with FIG. 6 discussed above, the engine model process simulation was a mission simulation designed collaboratively with the USFFC N5-OLW and the development team as a discrete-event simulation engine. It drives the assignment and execution of the processes over the course of a mission. This simulation operates as follows.

For the purpose of the model, let:
dᵢⱼ=the amount of time role i is required to spend on activity j. (If the role is not required for the activity, then dᵢⱼ=0);

$${d}_{max} = {max}_{i - 1 … R} ( {d}_{ij} ) ;$$

cₘ^{t}=the completeness of information product in at time t;
vᵢ=calculated completeness percentage attainable for the current execution of activity i;
vᵢ′=completeness percentage attained in the most recent execution of activity i;
α=activity repair coefficient, that is, the rate at which deficient information products input to an activity are improved by that activity;
βᵢ=minimum completeness threshold for activity i;
τᵢ=minimum execution time for activity i;
σ=completeness decay rate for activities;
w₁, w₂, w₃=the weights used in calculating vᵢ to balance the importance of preceding activity completeness, information product input completeness, and fulfillment of roles required, such that

$${\sum }_{k = 1}^{3} {w}_{k} = 1 ;$$

Nₚ=the number of activities in process p;
M=the total number of information product types.

Additionally, we employ the following variables:

$$r = \{ \begin{matrix}1 if role i is required for activity j \\ 0 otherwise\end{matrix} \\ {x}_{kj}^{t} = \{ \begin{matrix}1 if billet k is assigned to activity j at time t \\ 0 otherwise\end{matrix} \\ {a}_{mj} = \{ \begin{matrix}1 if info . prod . m is an input to activity j \\ 0 otherwise\end{matrix} \\ {l}_{ij} = \{ \begin{matrix}1 if activity i directly precedes activity j \\ 0 otherwise\end{matrix}$$

In some embodiments, when an activity (process variable or element) within a process is prompted to begin (either by the process schedule, or by the completion of all the preceding activities), the activity's potential completeness measure is computed to determine whether the activity has available the resources it needs such as: the required roles among available staff members; recently updated information products required by the activity; and required preceding activities. The completeness measure calculated for activity i at time t is:

$${v}_{i} = \frac{{w}_{1}}{{\sum }_{h = 1}^{{N}_{p}} {l}_{hi}} ( {\sum }_{h = 1}^{{N}_{p}} {l}_{hi} * {v}_{h}^{′ } ) + \frac{{w}_{2}}{{\sum }_{m = 1}^{M} {a}_{mi}} ( {\sum }_{m = 1}^{M} {a}_{mi} * {c}_{m}^{t} ) + \frac{{w}_{3}}{{\sum }_{n = 1}^{R} {r}_{ni}} ( {\sum }_{b = 1}^{B} {x}_{bi}^{t} )$$

The activity begins immediately if vᵢ≧βᵢ, that is, if the calculated value of the measure is above the minimum, user-defined threshold for completeness of the activity. (The user can define this completeness threshold differently for each activity to reflect varying priorities for the resources). If the calculated value is not sufficient (the activity does not have enough of the required resources available), the activity will delay its start. The required completion deadline for the activity remains fixed, so any delay in the activity start time reduces the overall duration of activity execution. As the duration of the activity is reduced, the overall quality of the actions, communications, and products of an activity declines.

At each time interval after the initial time at which the activity was prompted to begin, the activity's score is recalculated: increased with the possible addition of any newly available resources, and decreased by the decay rate due to the shorter time for execution and any resources that have become unavailable during the delay. That is, the new completeness measure value is computed after a starting delay, δ, as νᵢ(δ)=νᵢ−((1+σ)δ). If νᵢ(δ)≧βᵢ, then the activity may begin. Otherwise, the delay is continued until (1) the activity is able to begin, or (2) the delay has lasted too long (dₘₐₓ−δ<τ) at which time the activity fails.

The decay rate is represented here as σ. The user is able to configure this rate for each simulation run, with the constraint that 0≦σ<1. The larger the decay rate, the more severely the MOC organization is penalized for not starting its activities on time. A decay rate of zero represents the case in which there is no loss in completeness of the activity outputs even when activities do not have their full, required time period durations to execute.

The overall quality of activity is measured by the activity's calculated completeness measure value, which conveys to subsequent activities thus propagating the effects of shortages of input resources and time. The staff of subsequent activities can partially repair the deficiencies of prior activities, and this is represented by a multiplier on incomplete input we call the repair rate; whose effect grows with the temporal duration of the task. This repair rate is employed to calculate the concluded activity's completeness: ν′ᵢ=min(α*νᵢ·1), and it allows us to represent the reality that an organization may be able to recover from periods of resource shortages once the resources are again available during a period of more stable process execution. A repair rate of one indicates that no such recovery is possible. However, a repair rate configured to be any number greater than one will be the multiplier α, above, by which the activity completeness values are able to increase for each iteration The calculations given for activities throughout this section are used similarly to compute completeness percentages for the BRE.

Examples of other measures include but are not limited to: workload stress on entities; delay due to lack of resources; and percent of resources idle over time.

In some embodiments, a measure threshold is used as a benchmark against which to judge performance. For example, the example embodiments given here include a user-configurable minimum completeness threshold for the inputs to each activity. Altering this threshold allows the user to specify the percentage of input resources that must be available before an activity is able to begin. Some activities may be able to have significant progress made on them with partial information or staff, whereas other activities may not be able to proceed at all without a complete set of resources. Tailorable thresholds such as this minimum completeness threshold allow the user to provide extra tailoring of instruction to the process model.

Step 645 comprises sharing the results of the process model, typically by displaying the results of the model on a computer screen. In embodiments, the results of the model illustrate the individual measures or graphs illustrating workload on staff, process execution success, and the availability of information products to subsequent processes during the simulation. Analysts use these outputs to assess effectiveness of an organizational configuration, to diagnose potential failures, and to specify solutions.

In the example embodiments described above, due to the need for the results shared to allow diagnosis of specific staffing problems, each result comprises an assessment of a variable's success in the comparison of entity variables to process variables. By addressing each variable individually and then aggregated into groups by variable type, the measures shown for the example embodiments are designed to allow the user to answer questions about the activities, the organization and the information products. For each activity instance that occurs during the mission, we can calculate its completeness as the weighted sum of the states of its required inputs at the start of the activity, augmented by a repair rate such as 25%. The Input Weights are configurable by the user for each activity in order to capture variations in requirements across the three input categories: required information products, required roles, and required completion of prior activities. Staffing results are given for the OU employed in the mission, for the roles required and filled within the mission, and for the individual billets that staff the OU and fill the roles. As the mission evolves, the staff works on a variety of activities and battle rhythm events, taking on one of their potential roles at a time. For each organization element, the percent employment (0-100%) over time of the staff belonging to the organization element may be returned. For each role category, the percentage of all the billets capable of fulfilling the role who are currently employed by serving in the role may be returned over time. For each billet, the workload over the course of the mission may be returned. Finally, each information product has a “shelf life” that is configurable by the user. Each time an information product is updated by an activity or battle rhythm event, its completeness returns to 100% and remains there for the duration of the shelf life. After this time, the completeness of the information product decays as the information becomes increasingly outdated. For each information product, we return its completeness measure each time that it was required as input by an activity or a battle rhythm event.

Examples of other results include but are not limited to the frequency with which the OU were (un)able to provide sufficient staffing for the mission; the delay incurred due to insufficient staffing; the completeness gains achieved by the insertion of new, performance-improving technology; and the total degradation in mission performance due to lack of organizational congruence, measured in activity completion shortfalls.

The output of embodiments of the model in scenarios described above have thus far proved accurate and useful when compared to actual MOC staff process execution as observed by USFFC N5-OLW Subject Matter Experts, and during an initial application to a MOC accreditation exercise, as discussed below.

In another embodiment of the dynamic process modeling methods, the methods further include more advanced analysis tools, including reports that will support analysis and reporting by a MOC assessment team.

In another embodiment of the dynamic process modeling methods, the steps of operation further include recognizing that some of the process or entity variables and elements can have an associated decay. For example, information products have a user-specified shelf life after which their level of completion decays. Embodiments of the assembly and methods can capture this characteristic as well as recognize an activity which is unable to update or produce an information product on time will affect the ability of an activity which required the information product to execute completely. In these embodiments, a decay measure allows the methods to discover processes or BRE for which the timing has not been correctly configured. If a process required highly current information from a recurring event, for example, the process should be scheduled to occur as soon as possible after the event.

In yet another embodiment of the dynamic process modeling methods, the steps of operation further include configuring entity variables and elements to show the impact of role experience and proficiency on process execution speed (e.g., inexperienced personnel in a billet should slow activity execution while experienced staff accelerate activities).

### One Embodiment of the Dynamic Process Modeling Assembly:

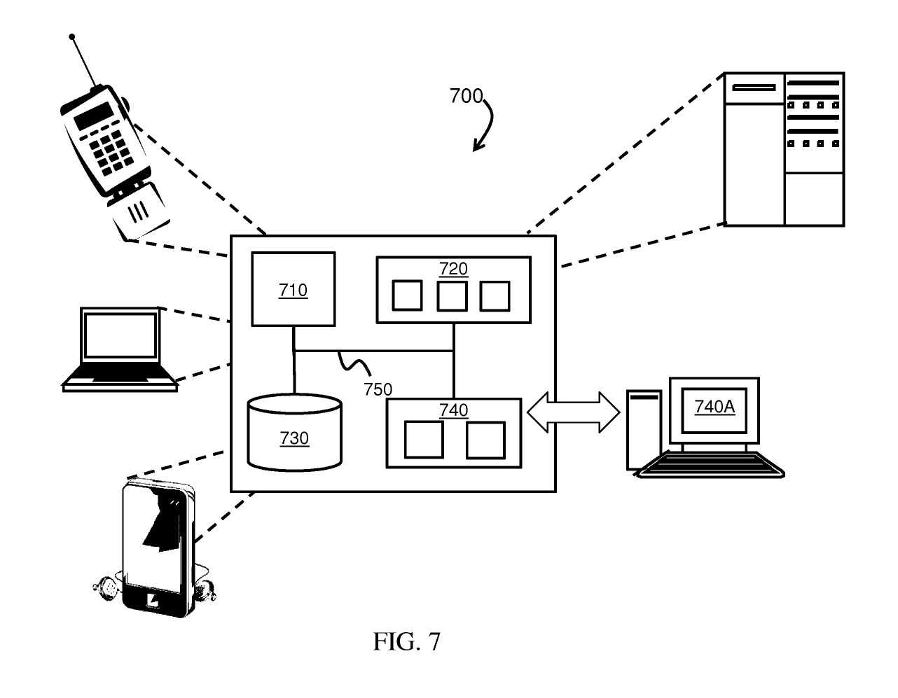

The various method embodiments of the dynamic process modeling assembly will be generally implemented by a computer executing a sequence of program instructions for carrying out the steps of the methods, assuming all required data for processing is accessible to the computer, which sequence of program instructions may be embodied in a computer program product comprising media storing the program instructions. One example of a computer-based dynamic process modeling assembly is depicted in FIG. 7 herein by which the method of the present invention may be carried out. The assembly includes a processing unit, which houses a processor, memory and other systems components that implement a general purpose processing system or computer that may execute a computer program product comprising media, for example a compact storage medium such as a compact disc, which may be read by processing unit through disc drive, or any means known to the skilled artisan for providing the computer program product to the general purpose processing system for execution thereby.

The program product may also be stored on hard disk drives within processing unit or may be located on a remote system such as a server, coupled to processing unit, via a network interface, such as an Ethernet interface. The monitor, mouse and keyboard can be coupled to processing unit through an input receiver or an output transmitter, to provide user interaction. The scanner and printer can be provided for document input and output. The printer can be coupled to processing unit via a network connection and may be coupled directly to the processing unit. The scanner can be coupled to processing unit directly but it should be understood that peripherals may be network coupled or direct coupled without affecting the ability of workstation computer to perform the method of the invention.

As will be readily apparent to those skilled in the art, the present invention can be realized in hardware, software, or a combination of hardware and software. Any kind of computer/server system(s), or other apparatus adapted for carrying out the methods described herein, is suited. A typical combination of hardware and software could be a general-purpose computer system with a computer program that, when loaded and executed, carries out the respective methods described herein. Alternatively, a specific use computer, containing specialized hardware or software for carrying out one or more of the functional tasks of the invention, could be utilized.

The present invention; or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or reproduction in a different material form.

FIG. 7 is a schematic diagram of one embodiment of a generic computer system 700. The system 700 can be used for the operations described in association with any of the computer-implemented methods described herein. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display information for a user interface on the input/output device 740.

The memory 720 stores information within the system 700. In some implementations, the memory 720 is a computer-readable storage medium. In one implementation, the memory 720 is a volatile memory unit. In another implementation, the memory 720 is a non-volatile memory unit.

The storage device 730 is capable of providing mass storage for the system 700. In some implementation, the storage device 730 is a computer-readable storage medium. In various different implementations, the storage device 730 may be a floppy disk device, a hard disk device, an optical disk device, or a tape device.

The input/output device 740 provides input/output operations for the system 700 and may be in communication with a user interface 740A as shown. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them such as but not limited to digital phone, cellular phones, laptop computers, desktop computers, digital assistants, servers or server/client systems. An apparatus can be implemented in a computer program product tangibly embodied in a machine-readable storage device, for execution by a programmable processor; and method steps can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and a sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube), LCD (liquid crystal display) or Plasma monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

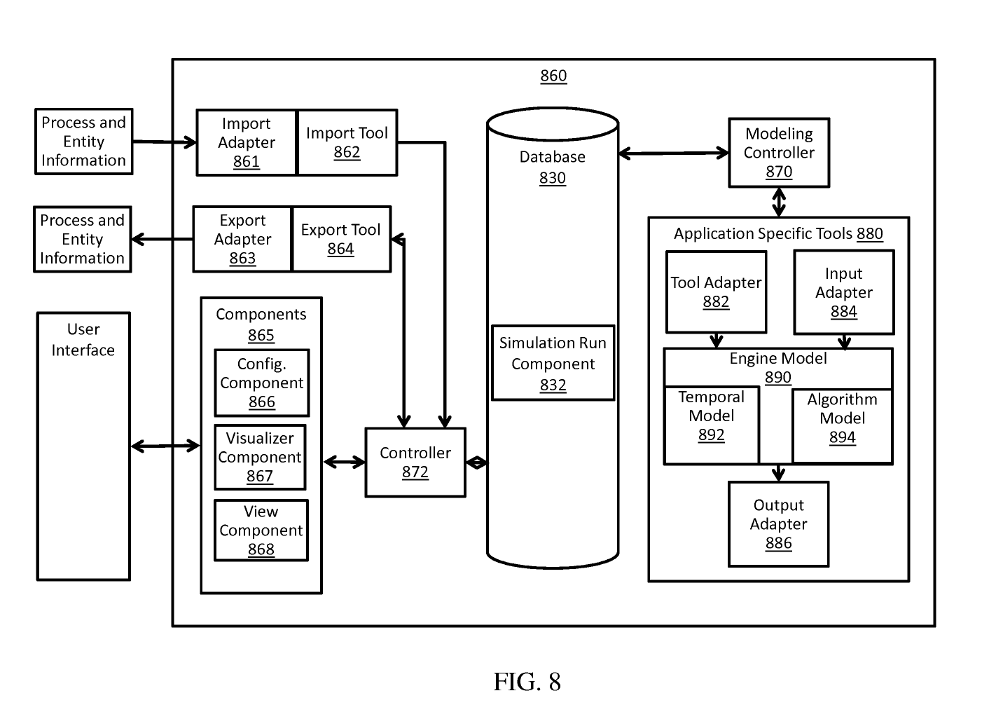

One embodiment of the computer program product capable of executing the described methods is shown in the functional diagram in FIG. 8. In this embodiment, data entry, configuration and basic modeling structure for this embodiment is generally provided using a computer program framework, called Adaptive Modeling Environment (AME). The AME provides reusable modules and tools that can be applied to application specific tools that allow users to add, delete, or edit most data objects against a rule set specific to that application. The data objects can be created within the application space or imported from external sources. The AME also provides reusable modules, or defined interfaces that allow connectivity to internal or external application specific tools, such as specific simulations, to that the program product and users can visualize and assess the results of the dynamic process modeling methods and systems.

Referring now to the embodiment of the computer program product 860 in FIG. 8. The input adapter module 861 and import tool module 862 imports process and entity information. For example, this information may include data specifying mission activities (tasks), activity information requirements, activity schedules, human resources (number and roles of staff) and organizational structure.

The database module 830 stores data, retrieves data used and provides data persistency for the assembly. This includes storing data received from the import tool module 862.

The modeling controller module 870 provides business logic. The modeling controller modules ensure the application specific rules are adhered to in order to protect the integrity of the data objects. The modeling controller module can prevent the validation of data objects that violate the application rules and will not allow them to be entered into the central database. Once a simulation is run, the modeling controller module 870 pulls this validated data out of the database and prepares it for the engine model 890. The modeling controller module can build a source object to share with the engine model that comprises data from the database. The modeling controller module also persists the output of the process simulation back into the database.

The application specific tools 880 generally represent the application specific components that can be modified within the framework of the computer program product. These application specific tools 880 are integrated with the modeling controller module 870 and the database module 830 according to well defined interfaces. These interfaces define specific behaviors and the engine model provides the implementation. These interfaces, together with hardware components such as the system bus, provide the receiving functionality to receive formatted data for execution by the models.

Within the application specific tools 880, the tool adapter module 882 provides the function of starting and configuring the process simulation with the engine model 890. Although the engine model 890 is shown within the computer program product 860, it is understood that engine model simulations can be internal or external to the application.

If needed, the input adapter module 884 can further process the data prepared by the modeling controller module as well as receive other types of data for the running of the simulations.

The engine model 890 contains application specific information necessary to run a process simulation and visualize the results. The engine model 890 includes the temporal model 892 and the algorithm model 894. The temporal model 892 provides the ability of the modeling assembly to execute a temporal simulation in the temporal space and the algorithm model 894 provides the algorithms or other computations for execution by the engine model. The engine model 890 provides the executing functionality to execute the process simulation given formatted data inputs as well as provides the determining functionality to determine a measure representing the simulations.

Referring back to FIG. 8, with the execution of the simulation, the output results are stored in the engine model 890 in a raw format specific to the model.

With this output, the output adapter module 886 translates the raw data into a format acceptable to the application for visualization and analysis.

The simulation run component module 832 provides an execution of the engine model 890. This component module can be configured to provide unique input or execute previous input to provide a unique instance of a simulation for visualization and storage.

Components 865 implement an interface which, in cooperation with the controller 872, provides the computer program product with the ability to: update and obtain configure input with the configuration component 866; request data from the database to visualize with the visualizer component module 867; and present the data from the visualizer component module 867 in different formats with the view component module 868. These components and modules access the database 830 and simulation run component module 832 by the means of the controller module 872. This data may exist in the application specific format or point to external sources (files, databases) from which additional data will be retrieved.

The export adapter module 863 and the export tool module 864 interface with the controller module 872 to allow data from the computer program product to be exported for use by other programs and/or systems.

The output of the process simulation can consist of several measures, which are presented graphically within a view component to help the analyst rapidly diagnose deficiencies in the staffing plan and mission schedule, and to refine their configuration. Examples of these measures include:
Activity Completeness: For each activity that is executed in the mission, we can calculate its completeness as the weighted sum of the states of its required inputs at the start of the activity, augmented by a repair rate such as 25%. The Input Weights can be configurable by the user for each activity in order to capture variations in requirements across the three input categories: required information products, required roles, and required completion of prior activities.
Manning Employment: As a mission simulation evolves, organizations dedicate staff (billets) in suitable roles (specific knowledge and skill packages) to activities. Each staff member takes on one of potentially many) roles at a time. For each organization element, we can return the percent employment (0-100%) of its staff over time. For each role, we can return over time the percentages of all the billets capable of fulfilling the role that are currently employed in the role. Finally, for each billet, we can return the instantaneous and average workload over the course of the mission. Instantaneous workload is currently dichotomous, as the billet is either employed or is idle.
Information Product Completeness: In some embodiments, each information product can have a shelf life that is configurable by the user. In these embodiments, the information product can be updated by an activity or battle rhythm event, so that its completeness returns to 100% and remains there for the duration of the shelf life. After this time, the completeness of the information product decays as the information becomes increasingly outdated. In embodiments, for each information product, we can return its completeness measure each time that it was required as input by an activity or a battle rhythm event.

### Testing Results of One Embodiment:

One embodiment of the MOC-PAT demonstrated the value of executing an operational architecture in software to assess complex Navy organizations and their processes. The MOC-PAT accurately modeled an operational staff's performance, and can provide analysts with insights into issues of staffing and scheduling of complex process flows. The speed of configuration and simulation enabled analysts to rapidly revise the model to diagnose performance failures and test alternative configurations of the organization.

The MOC-PAT was tested during a major Fleet exercise. Initial testing indicated that the MOC-PAT results are consistent with observed outcomes in the MOC when reliable data are used and processes in the model adjusted to reflect how the MOC staff conducts its mission tasking.

During the exercise, the MOC-PAT identified several areas of interest that were not noted during on-site observation. In general, MOC-PAT enabled the analyst to: identify overload conditions that require expansion of organic staff or remote staff, or changes to the process and its schedule; identify under loaded staff, who can potentially be reallocated to other missions; estimate the sustainability of operations over periods far longer than those tested in live accreditation exercises; identify skill and technology enhancement requirements to increase organizational capacity in critical processes; specify the impact of staff expertise/experience on organizational performance; and identify errors in architectural data. These findings were discovered during the exercise, because reconfiguring and running the MOC-PAT was so rapid. The findings helped focus the efforts and attention of on-site observers, and allowed identification of how the MOC staff had spontaneously developed workarounds for some issues. These discoveries were documented as “best practices” to share with other MOC staffs. Observers confirmed other problem areas identified in model runs during on-site observation. These discoveries provided confidence that the model was accurately describing how a MOC staff coped with an assigned mission set. The MOC-PAT was also used to explore how process synchronization and staffing issues might evolve over time, by running the model for mission sets that were far longer than those executed in the live exercise. This analysis identified issues for the MOC staff to explore after the exercise was complete.

Although this invention has been described in the above forms with a certain degree of particularity, it is understood that the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention which is defined in the claims and their equivalents.

We claim:

1. A computer based method for modeling a process, said method comprising:
receiving a first formatted data input representing a process element;
receiving a second formatted data input representing an entity element;
executing a process simulation with the first and second formatted data inputs; and
determining a measure whereby the measure represents the process simulation of the process element given the entity element.

2. The computer based method of claim 1 wherein the process element comprises at least one attribute of at least one business process.

3. The computer based method of claim 1 wherein the entity element comprises at least one attribute of a least one resource unit.

4. The computer based method of claim 1 wherein:
the process element defines at least one appropriate entity element to be used in the execution of the process simulation; and
the step of executing a process simulation further comprises determining whether the process element has the appropriate entity element and performing a process simulation of the process element given the entity element.

5. The computer based method of claim 1 wherein the measure is a completeness measure.

6. The computer based method of claim 5 wherein the completeness measure is associated with a decay rate whereby the process simulation modifies the completeness measure according to the decay rate.

7. The computer based method of claim 5 wherein the completeness measure is associated with a repair rate whereby the process simulation modifies the completeness measure according to the repair rate.

8. The computer based method of claim 5 wherein the completeness measure is a linking element required by a second process element.

9. The computer based method of claim 1 wherein the process simulation creates an information product and the measure is an information product completeness measure.

10. The computer based method of claim 9 wherein the information product completeness measure is associated with a decay rate whereby the process simulation can modify the information product completeness measure according to the decay rate.

11. The computer based method of claim 9 wherein the completeness measure is associated with a repair rate whereby the process simulation modifies the completeness measure according to the repair rate.

12. The computer based method of claim 9 wherein the information product is a linking element required by a second process element.

13. The computer based method of claim 1 wherein:
the process element is at least one attribute of at least one business process;
the entity element is a resource unit;
the process element defines an appropriate entity element to be used in the process simulation of the process element;
the step of executing the process simulation further comprises determining whether the entity element has the appropriate entity element and performing a temporal process simulation of the process element given the entity element;
the temporal simulation creates an information product and the measure is an information product completeness measure; and
the information product completeness measure is associated with a decay rate whereby the temporal simulation can modify the information product completeness measure according to the decay rate.

14. A computer based process for automatically modeling a process, said process comprising the steps of:
receiving a first formatted data input representing a process element;
receiving a second formatted data input representing an entity element;
executing a process simulation with the first and second formatted data inputs; and
determining a measure whereby the measure represents execution of the process simulation of the process element given the entity element.

15. The computer based process of claim 14, wherein the first formatted data input comprises at least one table having the process element.

16. The computer based process of claim 15, wherein the first formatted data input comprises at least one table having the process element and the process element represents a Joint Mission Essential Tasks List.

17. The computer based process of claim 15 wherein:
the process element is at least one attribute of at least one business process; and
the at least one attribute of the business process is formatted according to a Design Primitives and Patterns, Guidelines for the Design of Business Process Models.

18. The computer based process of claim 14 wherein the second formatted data input comprises at least one table having the entity element.

19. The computer based process of claim 18 wherein the second formatted data input is comprises at least one table having the entity element and the entity element represents a billet.

20. The computer based process of claim 14 wherein:
the first formatted data input comprises at least one table having the process element;
the second formatted data input comprises the at least one table having the entity element;
executing a process simulation of the process element given the entity element; and
determining a measure whereby the measure represents execution of the process simulation of the process element given the entity element.

21. The computer based process of claim 20 wherein the measure comprises a completeness measure.

22. The computer based process of claim 21 wherein the completeness measure is associated with a decay rate whereby the process simulation can modify the completeness measure according to the decay rate.

23. A computer based process modeling system comprising:
receiving functionality to receive a first formatted data input representing a process element and a second formatted data input representing an entity element;
executing functionality to execute a process simulation with the first and second formatted data inputs; and
determining functionality to determine a measure representing the process simulation of the process element given the entity element.

24. The computer based process modeling system of claim 23 wherein:
the computer based process modeling system further comprises a computer having a computer program product;
the receiving functionality is provided by the computer program product having an input adapter module;
the executing functionality is provided by the computer program product having a temporal model within an engine model; and
the determining functionality is provided by the computer program product having an algorithm model within the engine model.

25. The computer based process modeling system of claim 23 wherein the computer based process modeling system further comprises a computer having a computer program product to automatically define the process element, the entity element and determine the measure.
